(19) United States
(12) Patent Application Publication
(10) Pub. No.: US 2011/0319149 A1
(43) Pub. Date: Dec. 29, 2011

(54) Accurate Marketing System

(76) Inventor: Ho-Seok Hwang, Calgary (CA)

(21) Appl. No.: 13/168,013

(22) Filed: Jun. 24, 2011

(30) Foreign Application Priority Data
Jun. 25, 2010 (KR) 10-2010-0060370

(51) Int. Cl. A63F 9/24; G06Q 30/00

(52) U.S. Cl. 463/17; 705/14.66; 705/14.48; 705/14.39

(57) ABSTRACT

A community portal website system composed of multilevel community portal websites, employing a precision marketing method to pay resident members to look at advertisements placed by business members. Business members are able to specify a campaign period, a prepaid budget balance, and target consumer characteristics for the viewers of an advertisement. Resident members are paid by business members both directly and indirectly. Resident members who match the target consumer characteristics will be directly paid a fee for accessing an advertisement for a predetermined viewing time. Resident members are also paid indirectly by business members by means of a lottery fund. Business members contribute to the lottery fund every time their advertisements are viewed by resident members. A winner of the lottery fund is drawn regularly by the licensor or licensee, and the grand prize winner is paid a substantial amount.

The present invention is a community portal website system, composed of multilevel community portal websites, that employs a precision marketing methodology to pay resident members to look at advertisements placed by business members. Business members are able to specify a campaign period, a prepaid budget balance, and target consumer characteristics for the viewers of an advertisement. Resident members are paid by business members in two different ways. First, resident members who match the target consumer characteristics will be instantly paid a fee by a business member for accessing the business member's advertisement for a predetermined viewing time. Second, resident members are paid by business members indirectly through a lottery fund. Business members contribute to the lottery fund every time their advertisements are viewed by resident members. Lottery winners are drawn regularly, with the grand prize winners paid the largest amount.

### FIELD OF THE PRESENT INVENTION

The present invention relates to a community portal website system owned and operated by a licensor, who licenses community portal websites to licensees for a fee. Fees are generated by advertisers signed up as “business members,” who pay a monetary amount every time an advertisement is viewed by a community member who lives within a specified community and demographic and is signed up as a “resident member.” A portion of the monetary amount is paid directly to the resident member, and a portion is paid to a lottery fund. The licensee regularly selects resident members as lottery fund winners and awards them cash or prizes.

Each community portal website within the community portal website system is a multilevel website tailored for a greater geographic area such as a city or county, with subsystem websites tailored for smaller geographic areas within that greater geographic area. The preferred embodiment of the present invention envisions a community portal website as comprising a third level website (city level website), with second level websites (district level websites) as subsystems of the third level website, and first level websites (community level websites) as subsystems of the second level websites.

### BACKGROUND OF THE PRESENT INVENTION

In the advertising industry, consumer attraction is the most important factor. In 2010, the market size of the advertising industry in the United States was about $200 billion. Supposing there are 100 million households in the U.S., that means an average of $2,000 is spent by advertisers to get each household's attention. All of that money goes to advertising agencies and other “middlemen.” What if instead $2,000 was paid directly to consumers in the forms of cash rewards and prizes for their attention?

As an example, let's take a look at a business that prints and delivers flyers to households, paying 20 cents for each flyer (broken down into four cents for paper, seven cents for printing, and nine cents for delivery). The cost of making and distributing 10,000 flyers is 2,000 dollars. If, however, the company uploaded the flyer file on the web, it could pay as many as 10,000 consumers 20 cents to view it for the same amount of money. But it would not be worth a consumer's while to start his or her computer, browse the internet, log in to a website, and click on one ad to earn only 20 cents. However, it would be worthwhile to log into a consolidated website where hundreds of business members have uploaded their advertisements. Consumers would be willing to start up their computers, log in, and click advertisements if they could earn, say, $20 for viewing 100 ads. Moreover, a chance to win a lottery prize of $1,000,000 would gain the attention of most consumers. These are the main ideas of the present invention.

In the way of background, the website www.zip2save.com offers an online version of advertisement flyers so that people can read the flyers applicable to their city. However, because there is no consumer compensation program involved, it is unlikely that people will want to check the flyers online. Also in the way of background, in the 1990s, there were two companies, Cybergold and AllAdvantage, that paid people to view advertisements. The problem was the difficulty of getting advertisers because the process was so expensive. For example, if 30 million people viewed an advertisement, and anyone who clicked on the ad got paid fifteen cents each, with an additional ten cents charged for expenses, that amounted to $6,000,000 for one advertisement. At that time, the internet was in its start-up stage, before the advent of precision marketing database systems that enable advertisers to precisely select target consumer characteristics.

The Accurate Marketing System of the present invention means combining the concepts of “precision marketing” and “user verification.” Precision marketing simply means the system by which advertisers can precisely select target consumers by various factors. User verification means that the authenticity of the consumer is verified. This second aspect is most important because the advertiser pays for each consumer who views the advertisement, and the advertiser wants to make sure it is paying for the specifically targeted consumer.

U.S. Publication No. 2002/0095442 for “Creating Community Web Site” by Hunter et al., published on Jul. 18, 2002, shows a community website with links to information of local interest. The present invention differs from Hunter et al. in that the present invention is a “multi-level” website structure, with at least one “third-level website” representing a greater geographical area, with subsystem “second-level” and “first-level” websites representing smaller areas within that greater geographic area. In addition, Hunter et al. is primarily concerned with linking to local recreational pursuits, such as day trips, golf courses, and walking tours, whereas the present invention envisions providing a community's members the ability to earn revenue for viewing advertisements targeted to their specific community and demographic.

U.S. Pub. No. 2005/0262018 for “Business Method for Internet Advertising” by Soria, published on Nov. 24, 2005, shows a method of advertising on the internet that directs a portion of payment from the advertiser to the customer. Unlike the present invention, Soria does not utilize his method within a multi-level structure wherein persons within a specific geographic area are rewarded for viewing an advertisement.

U.S. Pub. No. 2002/1033402 for “Apparatus and Method for Recruiting, Communicating with, and Paying Participants of Interactive Advertising” by Faber et al., published on Sep. 19, 2002, shows a system by which advertisers pay participants to attend to a presentation online. Unlike the present invention, Faber et al. establishes a real-time communications link between the advertiser and the participants, whereas the present invention pays a viewer of an advertisement within a multi-level structure, based on the viewer's geographic area and demographic.

U.S. Pub. No. 2002/0147633 for “Interactive Advertisement and Reward System” by Rafizadeh, published on Oct. 10, 2002, shows a method of providing rewards to a customer who browses product-specific advertisements. Unlike the present invention, Rafizadeh does not employ a multi-level structure wherein persons within a specific geographic area and demographic are rewarded for viewing an advertisement.

### SUMMARY OF THE PRESENT INVENTION

The present invention is a community portal website system owned by a licensor, consisting of one or more community portal websites that are designed as multi-level structures. Each community portal website is licensed by a licensor to a licensee. In the preferred embodiment of the present invention, the highest level of the community portal website is at the third level (a city level website), with second level websites (district level websites) as subsystems of the third level website, and first level websites (community level websites) as subsystems of the district level websites. However, different embodiments of the community portal website structure are also envisioned, as in the examples given below:
Second level website (small city level website), first level websites (community level websites)
Third level website (county level website), second level websites (town level websites), first level websites (community level websites)
Fourth level website (state level website), third level websites (city level websites), second level websites (district level websites), first level websites (community level websites)
Fifth level website (national level website), fourth level website (state level website), third level websites (city level websites), second level websites (district level websites), first level websites (community level websites)

The community portal website structure described throughout this document, and which is the preferred embodiment of the present invention, is third level website (city level website), second level websites (district level websites), first level websites (community level websites). However, it should be understood that the structure of the present invention may embody other structures such as the examples given above, or any other structure that best meets the needs of the greater geographic area served by the present invention.

Within the community portal website structure, a first level website is provided free of charge to the community members served by that first level website. This is done by tailoring the first level website to a specific local community, whether to a local community association or the community itself. The first level website is the portal through which community members sign up free of charge to become “resident members” of the present invention, and through which they can post a limited number of announcements (i.e., free advertisements). This method of posting announcements is called the indirect posting method. Since the community portal website system utilizes a centralized database, the announcements placed by resident members through the first level website are also seen at the second level and third level websites. In addition, the first level website is the level through which resident members can view advertisements in order to receive payment. These advertisements will be targeted to specific target consumer characteristics of those within a specific community.

As an example of the precision marketing method, when a community-based nail shop advertises, its target market could be adult females within that specific community area. The present invention enables advertisers to precisely select a target consumer group by various factors, such as geographical area (i.e., specific communities), sex, age, occupation, etc. By employing the precision marketing method, the nail shop owner pays only adult females in that specific community who view that advertisement. By means of this precision marketing method, advertisers can save advertising costs while simultaneously paying consumers.

This solution is ideal for a community-based small business that can't afford to pay for expensive methods such as television, newspaper or online advertisements. Currently, the most popular advertisement method for small businesses is advertising flyers. The problem with this method is that so few people read them. Once or twice a week, a pile of flyers is delivered to a home, but they are thought of by most people as junk mail. Market research surveys show only two to three percent of people who receive ad flyers actually read them. The majority go directly into a recycling bin without being read. It is an inefficient means of advertising, but because it is relatively inexpensive, many small businesses still use it.

For example, if a small business wants to cover a local market of 10,000 households, the costs would break down as follows:
a) Paper costs: $0.04/sheet×10,000=$400
b) Printing costs (incl. material & labour): $0.07/sheet×10,000=$700
c) Delivery costs: $0.09/sheet×10,000=$900
d) Total costs: $0.20/sheet×10,000=$2,000

Since the best scenario is that only three percent of flyers will actually be read (i.e., 300 households), the actual cost for each “read flyer” is about $6.67 per flyer. This is an extremely inefficient means of advertising.

What if a business paid consumers for viewing an advertisement instead of paying middlemen like printers and delivery people? A standard TV commercial lasts 15 seconds, so if a consumer viewed an ad for a predetermined viewing time, such as 20 seconds, it would be a sufficient amount of time in which to communicate the business's message. Assuming a business pays $0.20 for each paper flyer, paying a consumer $0.10 for viewing an ad is a better bargain for the advertiser, and for the consumer too, since if a consumer views 30 ads a day, it will take only 10 minutes each day and he or she will make $3.00 extra income a day and $90 a month. In such a situation, consumers are naturally going to appreciate the advertisers. The advertisers are happy too, because at no extra cost consumers are being reached at a rate of effectiveness 3,233% greater than the conventional method. Finally, the website operating company (franchisee) is happy too, because when the advertiser pays $0.15 for a viewed ad, $0.05 goes to the franchisee.

But what if only a small number of consumers view the ad? If, for example, only 300 consumers view an ad, the advertiser will pay only $45. Compared to the conventional method, the advertiser saves $1,955 (97.75% of cost) because there is no printed paper going directly to recycling bins.

When a business places an advertisement on Google, MSN, Yahoo, or Youtube, anybody in the world can view it. But a local business based in Denver, Colo. doesn't want to pay a viewer who lives in New York, LA or somewhere in Asia. The solution is existing web technology that can tell a consumer's location by IP Address. For example, if a user accesses www.google.com from his or her home computer with an IP address of 67.169.132.112, Google's server recognizes that IP network address of 67.169.0.0 is allocated to an ‘class B’ ISP providing service in the Greater Chicago area. The Google server then pulls out the Chicago area advertisement pool from its database and shows them randomly to the user. If the three million users in the Greater Chicago area accessed Google.com, and were paid to view an ad placed there, the advertiser would pay $450,000 for a one-time advertisement. Therefore if a neighborhood bar advertised a grand opening on the web, even though the market segment to be targeted is probably 10,000 people that live in that neighborhood area, the ad would be viewed all over the Greater Chicago area, and at a cost of $450,000.

The solution is a method or system by which a local business can advertise precisely to target geographical communities and consumers only, thus attracting more customers while saving on advertising costs, and compensating viewers for their advertisement viewing labors. With the present invention, an advertiser can select certain community level websites (each servicing, say, 10,000 users) out of the numerous community level websites in the city level website.

The present invention enables local businesses to precisely target their consumer audience, and also to attract consumers by paying them to view advertisements. A chief difference between the present invention and previous community website concepts is that previous inventions have been “uni-level,” but the present invention is “multi-level.” For example, the website Kijiji (accessible at www.kijiji.com) is uni-level in structure, as is the network of Patch sites (accessible at www.patch.com). A visitor to either site is required to click a specific U.S. state, then a specific city or town within that state in order to access information. There is no information listed for the state, county, etc.; only the city or town has its own website. Many of these uni-level websites have failed or been unsuccessful, because in terms of classified advertisements the widest possible exposure is the key to success.

As an example, Bob is living in the town of Albany, Calif. The population of his town is only 18,500. He wants to sell his house and thinks that $250,000 is a fair price, so he posts an ad on the Patch site for Albany. Because Albany is a small town, only a hundred people click on the ad and he doesn't get an offer at that price. However, there are numerous neighbor cities and towns within 30 miles diameter of Albany. If Bob advertises in those cities and towns as well, he might attract more buyers and more offers. Advertisers want more exposure, which a uni-level community website cannot provide. For this reason, advertisers prefer higher level media to cover a wide area, not only a town. Now Bob has to advertise in 12 other cities individually, or pay a much higher advertisement fee to a major media outlet for county-wide coverage. Uni-level websites such as Patch.com may be a good source of information for local news and announcements, but are far less effective for advertisements.

A multi-level website such as the present invention is far different, and far more effective. An advertisement posted on the first level website is at the same time visible on the higher-level websites. When an advertiser places an advertisement for view at a community level website, it is simultaneously exposed at higher level websites, such as the district level and city level or county level. Advertisers are still visible in their community, but are also seen in wider geographical areas without any extra cost. This is possible because of the multi-level community website structure with a centralized database, which is one of the main concepts of the present invention.

Bob, the Albany resident, is simultaneously a resident of Alameda County in the state of California. With the present invention, when Bob places an advertisement at the Albany city level website, it will also be visible at the Alameda county level website, and the California state level website. Modern web technology makes it possible with a central database system.

The present patent is to cover not only the website of the present invention, but its ability to be used on mobile applications such as smart phones, etc. People can easily view ads on mobile devices on buses, subway trains or during coffee breaks.

The present invention could also be utilized as a market research or online survey tool. Researchers could access the database of resident members and pay those who respond to a survey.

In summary, the key aspects of the present invention are:
1. A multi-level community website structure with a centralized database
2. Consumer signs up as a resident member with his or her profile
3. Advertisers sign up as business members, and can precisely specify resident members' target consumer characteristics
4. A business member selects a campaign period and monetary amount to be paid when the advertisement is viewed
5. Resident members who match the target consumer characteristics and view the advertisement can submit an online ticket for entry into a lottery
6. Upon submitting the online ticket, the resident member is instantly paid a first portion amount of the monetary amount, with a second portion amount forwarded to a lottery fund, and a third portion amount paid to the licensee of the community portal website
7. The licensee (or licensor) regularly (e.g., weekly) draws grand prize winners using a prescribed method (explained below in the detailed description).

The licensor of the present invention is the owner and operator of the prototype community portal website system accessible via the internet at www.communityboard.ca. This community portal website system is in continuous development, and is owned and operated by Community Board Inc., an Alberta corporation in the City of Calgary, Alberta, Canada. The community portal websites within this community portal website system serve as the model for the community portal websites established in the present invention.

### BRIEF DESCRIPTION OF THE DRAWINGS

FIG. 1 is a diagram of a community portal website (20), with a third level website (70) and subordinate second level websites (60) and first level websites (30).

FIG. 2 illustrates the process of a resident member (50) viewing an advertisement and the apportioning of a monetary amount (155), with a first portion amount (160) apportioned to a resident member's personal account (55), a second portion amount (165) apportioned to a lottery fund (175), and a third portion amount (168) apportioned to the licensee (80).

FIG. 3 shows an example of an adview and lottery playing screen (190) with an advertisement (125), lottery numbers (195) chosen by the user, and “Submit” button (220).

FIG. 4 shows a sample table of the lottery number database (230) in which all possible two-digit lottery numbers are accounted for.

### DETAILED DESCRIPTION OF THE INVENTION

The present invention is a method of providing websites for use by community members, while simultaneously allowing them to get paid for viewing advertisements (125). In this method, the licensor (75) owns and operates a community portal website system (10) that consists of numerous community portal websites (20) operated by licensees (80). Each community portal website (20) is targeted to a geographic area, with multiple “subsystem” websites tailored to smaller areas within that geographic area. These subsystem websites, explained in further detail below, are adapted to the local communities they serve. The licensor (75) hosts these websites on a centralized database (25) which is a computer. A community portal website (20) can be structured in different ways, but the preferred embodiment of the present invention is envisioned as a community portal website (20) with a third level website (70), and subordinate second level websites (60) and first level websites (30).

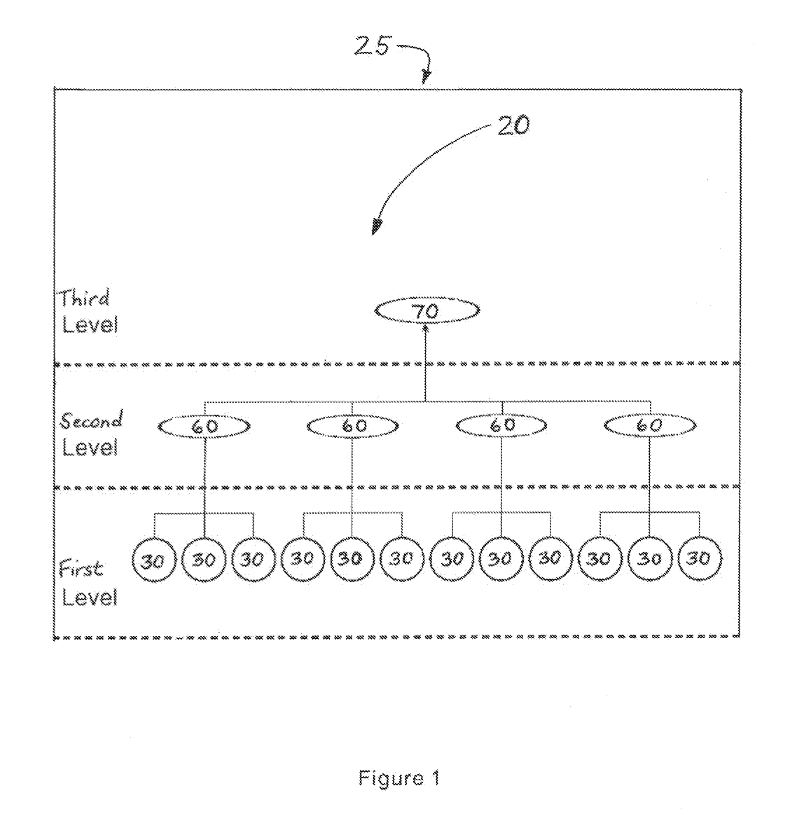

FIG. 1 is a diagram of a community portal website (20) in the preferred embodiment of the present invention, with a third level website (70) and its subordinate second level websites (60) and first level websites (30) placed on a centralized database (25). A community portal website (20) is shown with a number of first level websites (30) at the community level that are subsystems of second level websites (60) at the district level, which are in turn subsystems of a third level website (70) at the city level. It should be understood that other embodiments of the community portal website (20) may use additional levels or other structures (such as a third level website (70) at the county level, with subsystem second level websites (60) at the town level, etc.) without departing from the core concepts of the present invention. However, within the detailed description that follows, the preferred embodiment as shown in FIG. 1 is used as the model.

The present invention is envisioned as a for-profit corporation, with a licensor (75), licensees (80), business members (90) and resident members (50). In the preferred embodiment, the licensor (75) will operate the community portal website system (10), and licensees (80) will operate the community portal websites (20), although other management structures are possible. First level websites (30) are distributed free of charge to either community associations (40) or specific local communities (45) for use by community residents. The first level websites (30) are the portals through which community residents can become resident members (50) free of charge, and post a limited number of announcements (115) for free as well. These first level websites (30) are designed so that information entered in any first level website (30) is stored in the centralized database (25) and is thus accessible simultaneously at “all levels” of the community portal website (20), i.e., at the relevant first level websites (30), second level websites (60), and third level website (70).

When establishing a personal account (55) at a first level website (30), a resident member (50) will be required to complete a detailed consumer profile (130) that will reveal the target consumer characteristics (145) of the resident member (50). These target consumer characteristics (145) could include gender, age, income, occupation, education, household size, and other factors. The local community (45) of the resident member (50) is also important, since business members (90) will target resident members (50) who reside in particular target communities (185).

The second level websites (60) are the portals through which advertisers will routinely sign up as business members (90) of the community portal website (20) and place advertisements (125). However, business members (90) may also be permitted to sign up on higher level websites depending on the size of the business and its locations. (For example, a chain store with a national reach would be permitted to sign up as a business member (90) at a national level website.) Due to the centralized database (25), every advertisement (125) posted at a second level website (60) is posted simultaneously at the relevant first level websites (30) and third level website (70).

When placing an advertisement (125), business members (90) select information such as target communities (185) and target consumer characteristics (145) of the resident members (50) who will be paid to view the advertisement (125). A business member (90) will be asked to:
1) Select the targeted first level websites (30) assigned to one or more target communities (185). Some or all of the communities in the city can be selected
2) Select a campaign period (135) (i.e., date range) of the advertisement (125)
3) Deposit a prepaid budget balance (140)
4) Specify target consumer characteristics (145), such as, age, sex, occupation, interest, etc.

For example, the business member (90) selects:
1) First level websites (30) serving target communities (185) A, B, and C
2) Campaign period (135) of Oct. 10, 2011 until Oct. 24, 2011
3) Prepaid budget balance (140) of $2,000 for advertisement (125)
4) Target consumer characteristics (145): age: 15 or older; sex: male; occupation: any

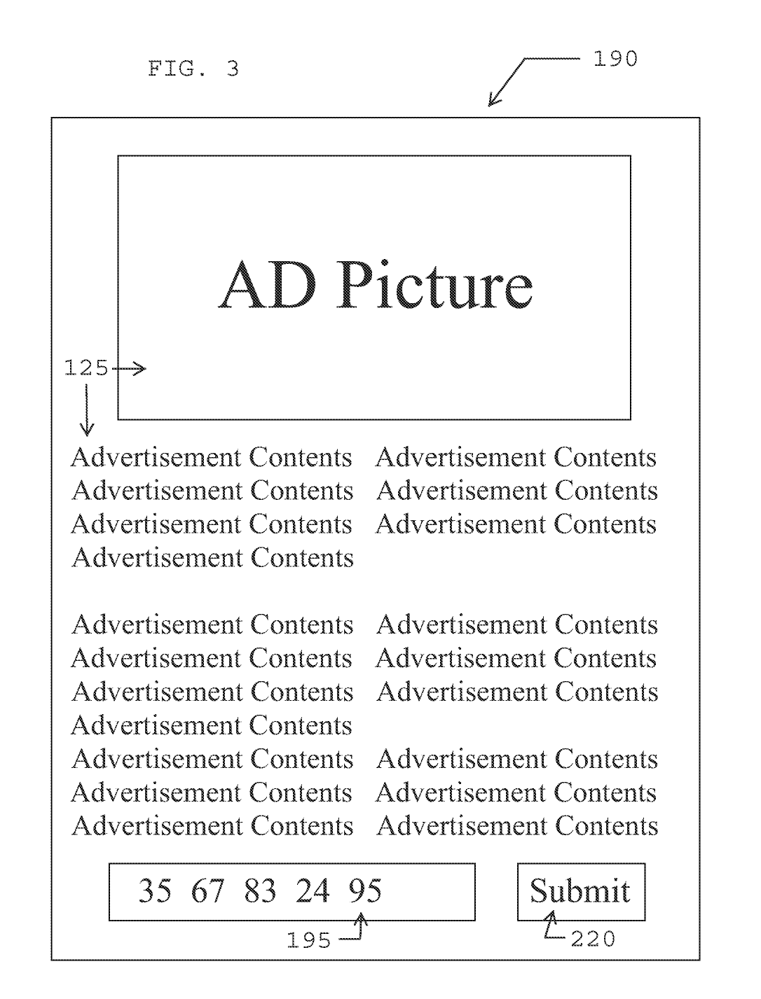

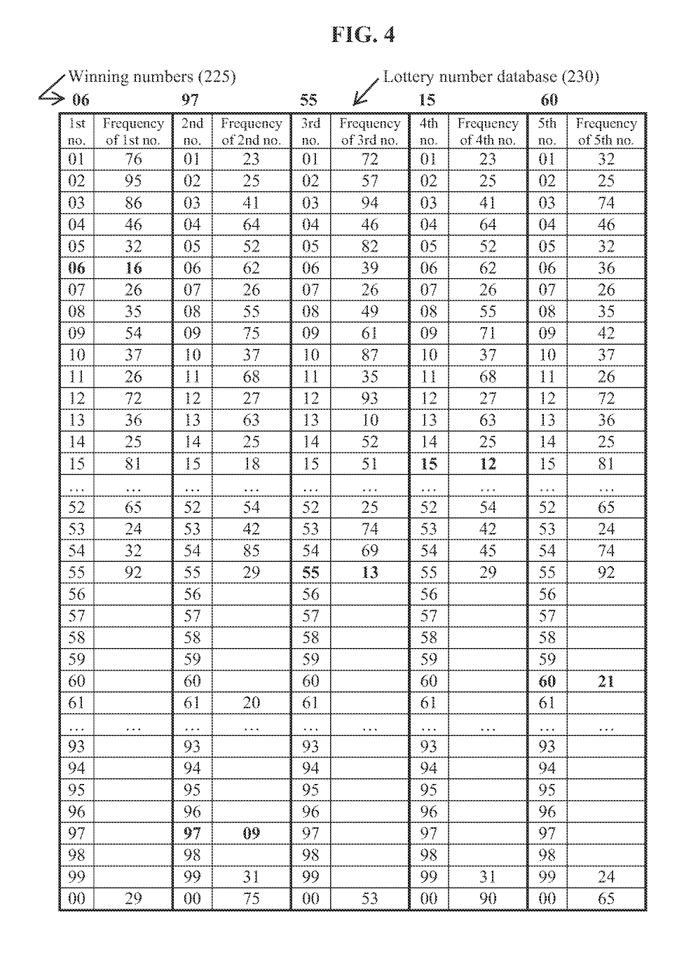

During the campaign period (135), when a resident member (50) of target communities (185) A, B, or C who falls within the target consumer characteristics (145) (in this example, age: 15 or older; sex: male; occupation: any) clicks on and views the specific advertisement (125) for a predetermined viewing time (150) (e.g., 20 seconds), then he will be directed to enter five two-digit lottery numbers (195) within an adview and lottery playing screen (190) (shown in FIG. 3 and described in detail further below). When he clicks the “Submit” button (220), a monetary amount (155) (e.g., 15 cents) is debited from the prepaid budget balance (140), and a first portion amount (160) (e.g., 5 cents) is instantly credited to the personal account (55) of the resident member (50). (However, if the resident member (50) views the same advertisement (125) in the second level website (60) or third level website (70), he does not receive payment.) A second portion amount (165) (e.g., 5 cents) is transferred to a lottery fund (175). A third portion amount (168) (e.g., 5 cents) is sales revenue (120) for the licensee (80) of the present invention. The lottery numbers (195) submitted by the resident member (50) are entered into a lottery number database (230). The licensee (80) or licensor (75) regularly draws winning numbers (225) from the lottery database (230) (shown in FIG. 4 and described in detail further below), selecting the least frequently entered lottery numbers (195) as the winning numbers (225), and paying the winners money or prizes out of the lottery fund (175).

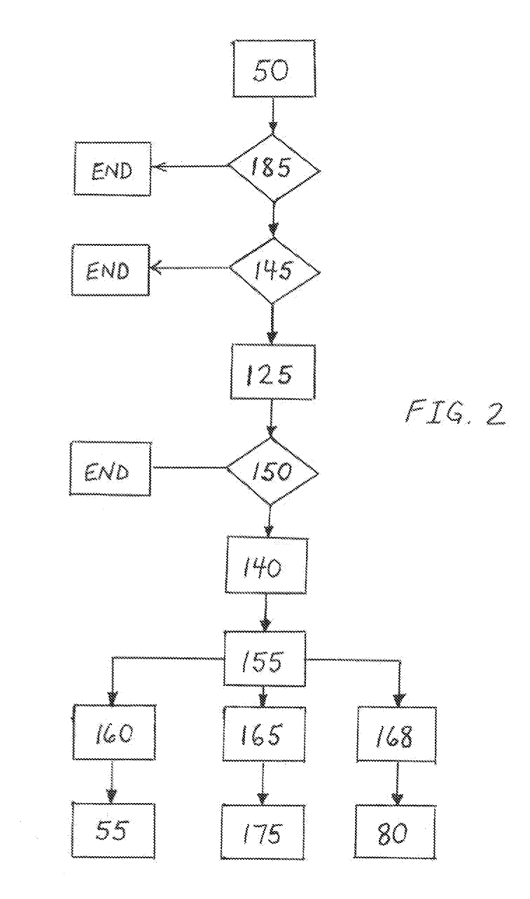

FIG. 2 illustrates the process of a resident member (50) viewing an advertisement and the apportioning of a monetary amount (155), with a first portion amount (160) apportioned to a resident member's personal account (55), a second portion amount (165) apportioned to a lottery fund (175), and a third portion amount (168) apportioned to the licensee (80). A resident member (50) of one of the target communities (185) who meets the target consumer characteristics (145) views a specific advertisement (125) for a predetermined viewing time (150). From the prepaid budget balance (140) the monetary amount (155) is then deducted, and the first portion amount (160) is credited to the resident member's personal account (55), the second portion amount (165) is credited to the lottery fund (175), and the third portion amount (168) is credited to the licensee (80).

FIG. 3 shows an example of an adview and lottery playing screen (190) in the preferred embodiment of the present invention. The adview and lottery playing screen (190) contains an advertisement (125), a section where five two-digit lottery numbers (195) are entered by the user, and a “Submit” button (220) by which the user submits the lottery numbers (195).

FIG. 4 shows a sample table of the lottery number database (230) in which all possible two-digit lottery numbers are accounted for. On the top of the lottery number database (230) are shown example winning numbers (225) (the numbers being 06, 97, 55, 15 and 60). The winning numbers (225) that are selected are the least frequently selected lottery numbers submitted by resident members. Every time a resident member submits five two-digit lottery numbers from an adview and lottery playing screen, the lottery numbers are counted and saved into the lottery number database (230) placed within the centralized database. The least frequently entered lottery numbers are chosen as the winning numbers (225).

Continuing with the detailed description of the preferred embodiment of the present invention, an advertisement (125) is automatically taken down when the prepaid budget balance (140) is depleted. In order to extend the advertisement (125) for a longer campaign period (135), the business member (90) must add more funds to the prepaid budget balance (140). On the other hand, if there are still funds remaining in the prepaid budget balance (140) at the end of the campaign period (135), the funds remaining are refunded to the business member (90). This aspect of the present invention guarantees a business member (90) pays only when his or her advertisement (125) is viewed by a resident member (50) who matches the specified target consumer characteristics (145). Business members (90) can thus increase their consumer reach ratio since resident members (50) are paid only when they view advertisements (125) aimed at their target demographic. Business members (90) and resident members (50) meet directly on the present invention, and they split the advertisement costs that the business members (90) saved by not paying middlemen.

As another example, a neighborhood bar owner is a business member (90) advertising only to a target community (185) with 10,000 residents that is served by a first level website (30). The business member (90) specifies the target consumer characteristics (145) as males over 18 years of age within the target community (185), so the estimated number of his target consumers is 4,000. The owner deposits a prepaid budget balance (140) of $600 ($0.15×4,000) for a campaign period (135) of two weeks. During the campaign period (135), 2,000 resident members (50) of the target community (185) who meet the target consumer characteristics (145) view the advertisement (125) for the predetermined viewing time (150). For each view, $0.15 is debited from the prepaid budget balance (140), with a first portion amount (160) of $0.05 deposited into the personal account (55) of each viewing resident member (50), a second portion amount (165) of $0.05 deposited into the lottery fund (175), and a third portion amount (168) of $0.05 paid to the licensee (80). With payment of $0.15 per view, a total of $300 is debited from the prepaid budget balance (140). The remaining prepaid budget balance (140) of $300 is refunded to the business member (90) upon the expiration of the campaign period (135).

In summary, each community portal website (20) has been intentionally designed with a unique membership system that breaks down to resident members (50) and business members (90). In order to place an announcement (115) on the community portal website (20), the resident member (50) must sign up for a free personal account (55) and log into the community portal website (20). Resident members (50) are those who live in one of the communities served by the community portal website (20). The resident members (50) are allowed to post a limited number of announcements (115) without charge via a computer. Resident members (50) are only allowed to post an announcement (115) through the first level website (30) of the specific community in which they reside. For business members (90), in order to place an advertisement (125) on the community portal website (20), the business member (90) must sign up for a business account (170). Each first level website (30) is provided free of charge by the licensee (80) for use by a specific community association (40) or local community (45). This is done by tailoring the first level website (30) to a community association (40) for use by the community association (40) and its community residents, or by tailoring the first level website (30) to a particular local community (45) (i.e., neighborhood, political district, etc.). Each first level website (30) is a subsystem of a second level website (60), and each second level website (60) is a subsystem of a third level website (70), just as each community is a subsystem of the district and city where it is geographically located. At the third level website (70) are displayed all announcements (115) and advertisements (125) placed at the subsystem first level websites (30) and second level websites (60), since the community portal website system (10) utilizes a centralized database (25).

In an additional embodiment of the present invention, resident members (50) are not required to be verified when they sign up as resident members (50), but without verification they may not be paid or may be paid a lower amount (e.g., 1 cent) for each advertisement (125) viewed. However, if the resident member (50) provides a government-issued identification number, such as one found on a driver's license or passport, the status of the resident member (50) is changed to verified, and the resident member (50) can then be paid in full (i.e., 5 cents) for viewing an advertisement (125). In addition, only verified members are eligible to win additional prizes.

The business model of the present invention is also suitable as a smart phone mobile application. Resident members (50) can easily access their first level website (30) with smart phones, and earn extra income while commuting on a bus or train, or during a coffee break. Therefore it is desired that the present invention be protected under patent in the mobile application area as well.

The present invention can also be applied as a market research or online survey tool as well. Researchers or institutes can gain precise access to consumers or a respondent database for a fee, and pay respondents for their time and labor.

In conclusion, the present invention is a method for creating a community portal website system (10), the method comprising creating at least one community portal website (20) within the community portal website system (10) on a computer; creating a third level website (70), the third level website (70) being a subsystem of the community portal website (20) on the computer; creating a second level website (60), the second level website (60) being a subsystem of the third level website (70) on the computer; creating a first level website (30), the first level website (30) being a subsystem of the second level website (60) on the computer; the computer providing use of the community portal website (20) free of charge to a resident member (50) of a local community (45); the resident member (50) establishing a personal account (55) containing a detailed consumer profile (130) having target consumer characteristics (145); the computer receiving an announcement (115) placed by the resident member (50) on the community portal website (20); the computer providing use of the community portal website (20) to a business member (90); the business member (90) establishing a business account (170); the computer receiving an advertisement (125) placed by a business member (90) on the community portal website (20); and the computer charging the business member (90) a monetary amount (155) when an advertisement (125) placed by the business member (90) on the community portal website (20), is viewed by a resident member (50) according to target consumer characteristics (145) set by the business member (90);

In addition, the present invention further comprises transferring a prepaid budget balance (140) from the business member (90) for the advertisement (125) to a licensee (80) of the community portal website (20); the resident member (50) viewing the advertisement (125) on an adview and lottery playing screen (190) for a predetermined viewing time (150); the resident member (50) selecting and submitting lottery numbers (195) after viewing the advertisement (125) for a predetermined viewing time (150); transferring the monetary amount (155) from the prepaid budget balance (140) upon said viewing the advertisement (125) for a predetermined viewing time (150); giving a first portion amount (160) of the monetary amount (155) to the resident member (50) for said viewing the advertisement (125) for a predetermined viewing time (150); giving a second portion amount (165) of the monetary amount (155) to a lottery fund (175) for said viewing the advertisement (125) for a predetermined viewing time (150); giving a third portion amount (168) of the monetary amount (155) to the licensee (80) for said viewing the advertisement (125) for a predetermined viewing time (150), the third portion amount (168) being sales revenue (120).

Finally, the present invention further comprises selecting winning lottery numbers (195), choosing a winning resident member (50) that has chosen the winning lottery numbers, and paying the winning resident member from the lottery fund (175); wherein said selecting winning lottery numbers (195) is by frequency, with the least frequently selected lottery numbers (195) picked as winning numbers; and further comprising hosting and maintaining the at least one community portal website (20) on a centralized database (25) so that the third level website (70), the second level website (60), and the first level website (30) are connected and networked together.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

I claim:

1. A method for creating a community portal website system, the method comprising:
creating at least one community portal website within the community portal website system on a computer;
creating a third level website, the third level website being a subsystem of the community portal website on the computer;
creating a second level website, the second level website being a subsystem of the third level website on the computer;
creating a first level website, the first level website being a subsystem of the second level website on the computer;
the computer providing use of the community portal website free of charge to a resident member of a local community;
the resident member establishing a personal account containing a detailed consumer profile having target consumer characteristics;
the computer receiving an announcement placed by the resident member on the community portal website;
the computer providing use of the community portal website to a business member;
the business member establishing a business account;
the computer receiving an advertisement placed by a business member on the community portal website; and
the computer charging the business member a monetary amount when an advertisement placed by the business member on the community portal website, is viewed by a resident member according to target consumer characteristics set by the business member;

2. The method of claim 1, further comprising transferring a prepaid budget balance from said business member for the advertisement to a licensee of the community portal website.

3. The method of claim 2, further comprising the resident member viewing the advertisement on an adview and lottery playing screen for a predetermined viewing time.

4. The method of claim 2, further comprising the resident member selecting and submitting lottery numbers after viewing the advertisement for a predetermined viewing time.

5. The method of claim 3, further comprising transferring the monetary amount from the prepaid budget balance upon said viewing the advertisement for a predetermined viewing time.

6. The method of claim 4, further comprising giving a first portion amount of the monetary amount to the resident member for said viewing the advertisement for a predetermined viewing time.

7. The method of claim 4, further comprising giving a second portion amount of the monetary amount to a lottery fund for said viewing the advertisement for a predetermined viewing time.

8. The method of claim 4, further comprising giving a third portion amount of the monetary amount to the licensee for said viewing the advertisement for a predetermined viewing time.

9. The method of claim 8, the third portion amount being sales revenue.

10. The method of claim 6, further comprising selecting winning lottery numbers, choosing a winning resident member that has chosen the winning lottery numbers, and paying the winning resident member from the lottery fund.

11. The method of claim 10, wherein said selecting winning lottery numbers is by frequency, with the least frequently selected lottery numbers picked as winning numbers.

12. The method of claim 1, further comprising hosting and maintaining the at least one community portal website on a centralized database so that the third level website, the second level website, and the first level website are connected and networked together.
